(19) United States
(12) Patent Application Publication
(10) Pub. No.: US 2015/0194855 A1
(43) Pub. Date: Jul. 9, 2015

(54) ROTOR OF ROTARY ELECTRIC MACHINE

(71) Applicants: Kaoru KUBA, Miyoshi-shi (JP); Ryoji MIZUTANI, Nagoya-shi (JP); Hiroki KATO, Toyota-shi (JP); Eiji YAMADA, Owariasahi-shi (JP); Shintaro CHINEN, Toyata-shi (JP); Hideo NAKAI, Nisshin-shi (JP); Kenji HIRAMOTO, Owariasahi-shi (JP)

(72) Inventors: Kaoru Kubo, Miyoshi-shi (JP); Ryoji Mizutani, Nagoya-shi (JP); Hiroki Kato, Toyota-shi (JP); Eiji Yamada, Owariasahi-shi (JP); Shintaro Chinen, Toyota-shi (JP); Hideo Nakai, Nisshin-shi (JP); Kenji Hiramoto, Owariasahi-shi (JP)

(73) Assignee: TOYOTA JIDOSHA KABUSHIKI KAISHA, Toyota-shi, Aichi-ken (JP)

(21) Appl. No.: 14/419,307

(22) PCT Filed: Jul. 22, 2013
(86) PCT No.: PCT/IB2013/001588

§ 371 Date: Feb. 3, 2015

(30) Foreign Application Priority Data
Aug. 7, 2012 (JP) 2012-174964

(51) Int. Cl. H02K 3/487; H02K 11/04

(52) U.S. Cl. CPC H02K 3/487; H02K 11/042

(57) ABSTRACT

A rotor of a rotary electric machine includes a rotor core having a plurality of rotor salient poles disposed on an outer periphery of the rotor core in a circumferential direction of the rotor core, rotor coils wound on the rotor salient poles, and a retainer member provided to close a slot formed between the rotor salient poles. The retainer member includes a leg portion extending radially in the slot between rotor coils wound on two rotor salient poles adjacent to each other in the circumferential direction and fixed to the rotor core, and beam portions extending in the opposite circumferential directions each other from a radially outer end portion of the leg portion and that close an outer periphery of the slot. The leg portion of the retainer member is provided with protrusion portions protruded in circumferential directions to engage with the coil winding that forms the rotor coils.

### BACKGROUND OF THE INVENTION

1. Field of the Invention

The invention relates to a rotor of a rotary electric machine and, more particularly, to a rotor of a rotary electric machine which is provided with rotor coils.

2. Description of Related Art

There exists a type of rotary electric machine that employs a rotor provided with rotor coils. For example, Japanese Patent Application Publication No. 2009-112091 (JP 2009-112091 A) describes a rotary electric machine that forms a rotating magnetic field by causing alternating current through stator coils and causes a spatial harmonic component of the rotating magnetic field to link with rotor coils so as to produce induced current in the rotor coils. In this construction, the rotor coils are individually wound on salient poles of the rotor, and the rotor coils are short-circuited via diodes so that the induced currents are rectified, whereby each salient pole of the rotor functions as a magnet that has a fixed magnetization direction. The foregoing patent application publication states that this construction is able to utilize torque caused by the spatial harmonic component in addition to the torque caused by the fundamental component of the rotating magnetic field.

In rotary electric machine described in JP 2009-112091 A, when the rotor rotates, centrifugal force acts on the rotor coils wound on the rotor salient poles. Therefore, it is preferable to provide a retainer member that prevents the rotor coils from flying radially outward from the rotor salient poles due to the centrifugal force. In that case, it is desirable that the retainer member be devised so as to secure sufficiently large winding spaces for rotor coils that are to be wound on the rotor salient poles while securing a strength that retains the rotor coils against the aforementioned centrifugal force.

### SUMMARY OF THE INVENTION

The invention provides a rotor of a rotor electric machine which secures large coil winding spaces between rotor salient poles while securing retention of the rotor coils wound on the rotor salient poles.

An aspect of the invention relates to a rotor that includes: a rotor core having a plurality of rotor salient poles that are disposed on an outer periphery of the rotor core in a circumferential direction of the rotor core; rotor coils wound on the rotor salient poles; and a retainer member provided so as to close a slot formed between the rotor salient poles. The retainer member has a leg portion which extends in a radial direction of the rotor between the rotor coils wound on two rotor salient poles adjacent to each other in the circumferential direction and whose radial-direction inner end portion is fixed to the rotor core, and a beam portion that is connected integrally to a radial-direction outer end portion of the leg portion. The beam portion includes a first beam portion and a second beam portion that extend in opposite circumferential directions from each other from the radial-direction outer end portion of the leg portion so as to close a radial-direction outer side of the slot. The leg portion of the retainer member is provided with at least one protrusion portion that is protruded in the circumferential direction and that engages with a coil winding that forms the rotor coils.

The at least one protrusion portion may be a plurality of protrusion portions that are formed on two opposite surfaces of the leg portion in the circumferential direction and that are spaced from each other in the radial direction.

A circumferential-direction distal end portion of the beam portion of the retainer member may be latched to a radial-direction outer end portion of a corresponding one of the rotor salient poles.

The rotor coils may include: induction coils each of which is wound on a distal end-side portion of one of the rotor salient poles and in which induced current is produced due to linkage by magnetic flux of a rotating magnetic field formed by a stator; a rectification portion connected to the induction coils so as to rectify the induced current; and common coils that are each wound on a proximal end-side portion of one of the rotor salient poles and that magnetize the rotor salient poles with different polarities alternately in the circumferential direction by the induced current produced in each induction coil.

In this construction, a portion of the leg portion of the retainer member which is located between the induction coils located at opposite sides in the circumferential direction in the slot may be provided with a magnetic member.

According to the rotor of a rotary electric machine of the invention, since the coil windings of the rotor coils on which centrifugal force acts during rotation of the rotor engage with the at least one protrusion portion of the leg portion, part of the centrifugal force can be borne by the leg portion of the retainer member. Therefore, in comparison with a construction in which the centrifugal force on the rotor coils is borne by the at least one beam portion alone, the construction of the invention allows reduction of the wall thickness of a connecting portion between the leg portion and the at least one beam portion. Hence, a large coil winding space between the rotor salient poles can be secured.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a general sectional view showing portions of a rotary electric machine provided with a rotor as an embodiment of the invention which correspond to a part of a circumference of the rotor;

FIG. 2 is an enlarged view of the rotor shown in FIG. 1;

FIG. 3 is an enlarged view of a portion A shown in FIG. 2;

FIG. 4 is a schematic diagram showing how magnetic flux generated by the induced currents that flow in the rotor coils flows in the rotor of the rotor electric machine shown in FIG. 2;

FIG. 5 is a circuit implementation diagram in which rotor coils are connected to diodes, the diagram corresponding to FIG. 4;

FIG. 6 is a diagram showing an equivalent circuit of a connecting circuit for a pair of rotor coils that are wound on two rotor salient poles that are adjacent to each other in the circumferential direction of the rotor in the rotary electric machine shown in FIG. 1;

FIG. 7 is a diagram showing a comparative example in which a leg portion of a retainer member is not provided with a protrusion portion, the diagram corresponding to FIG. 2;

FIG. 8 is a diagram showing an example in which the protrusion portions formed on the leg portion of the retainer member have a triangular shape, the diagram corresponding to FIG. 2;

FIG. 9 is an enlarged view of a portion B shown in FIG. 8; and

FIG. 10 is a diagram showing another example in which the protrusion portions formed on the leg portion of the retainer member have a triangular shape, the diagram corresponding to FIG. 2.

### DETAILED DESCRIPTION OF EMBODIMENTS

Embodiments of the invention will be described in detail hereinafter with reference to the accompanying drawings. In the description below, concrete shapes, materials, numerical values, directions, etc. are mere illustrations for facilitating the understanding of the invention, and can be appropriately changed in accordance with uses, purposes, specifications, etc. Furthermore, if two or more embodiments, modifications, etc. are described below, it has been conceived from the beginning that features of the embodiments, modifications, etc. may be combined as appropriate for use.

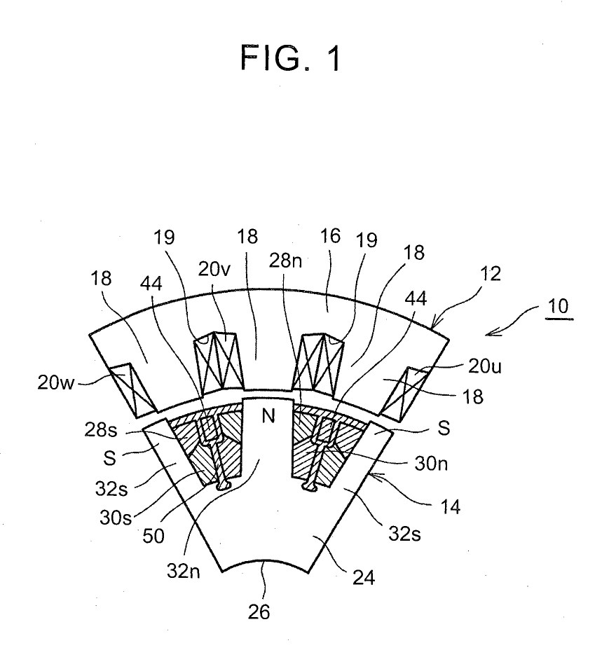

FIGS. 1 to 6 show a rotary electric machine 10 that includes a rotor as an embodiment of the invention. FIG. 1 is a schematic sectional view of a portion of a stator 12 and a portion of a rotor 14 of a rotary electric machine 10 which correspond to a part of a circumference of the rotor 14, in other words, which are portions in a circumferential direction of the rotor 14. As shown in FIG. 1, the rotary electric machine 10, which functions as an electric motor or an electricity generator, includes the stator 12 fixed to a casing (not shown) and the rotor 14 that is disposed facing a radially inner side of the stator 12 with a predetermined space left therebetween and that is rotatable relative to the stator 12. Incidentally, the “radial direction” (or “radial”) refers to a radial direction orthogonal to the rotation center axis of the rotor 14 unless otherwise mentioned. The “circumferential direction” (or “circumferential”) refers to a direction along a circle drawn about the rotation center axis of the rotor 14 unless otherwise mentioned. Furthermore, the “axis direction” refers to an axis direction of the rotor 14 unless otherwise mentioned.

The stator 12 includes a stator core 16. The stator core 16 is formed from a magnetic material, for example, a laminate of metal sheets, such as silicon steel sheets or the like, or a powder magnetic core or the like. An inner peripheral surface of stator core 16 has, at a plurality of locations in the circumferential direction, a plurality of teeth 18 protruded radially inward toward the rotor 14. The teeth 18 are spaced from each other in the circumferential direction. Slots 19 are formed between the individual teeth 18.

Stator coils 20u, 20v and 20w of a plurality of phases (e.g., three phases that include the U phase, the V phase and the W phase) are wound on the stator core 16. The stator coils 20u, 20v and 20w of the three phases are wound around the teeth 18 of the stator core 16 through the slots 19 by a concentrated winding method. In this example, three teeth 18 around which the stator coils 20u, 20v and 20w of the three phases (the U phase, the V phase and the W phase) are wound constitute a pair of poles. By electrifying the stator coils 20u, 20v and 20w of the plurality phases with, for example, three-phase alternating current, the teeth 18 are magnetized so that a rotating magnetic field that rotates in the circumferential direction can be formed around the stator 12.

The rotor 14 includes a generally cylindrical rotor core 24 that is formed from a magnetic material such as a powder magnetic core, a laminate of a plurality of magnetic steel sheets, etc. Two end plates (not shown) may be disposed on opposite sides of the rotor core 24 in the axis direction. A shaft hole 26 extends in the axis direction through a center portion of the rotor core 24. In the shaft hole 26, a shaft (not shown) is inserted and fixed. The shaft fixed in this manner is rotatably supported by bearing members at the casing or the like. In this manner, the rotor 14 is provided so as to be rotatable relative to the stator 12.

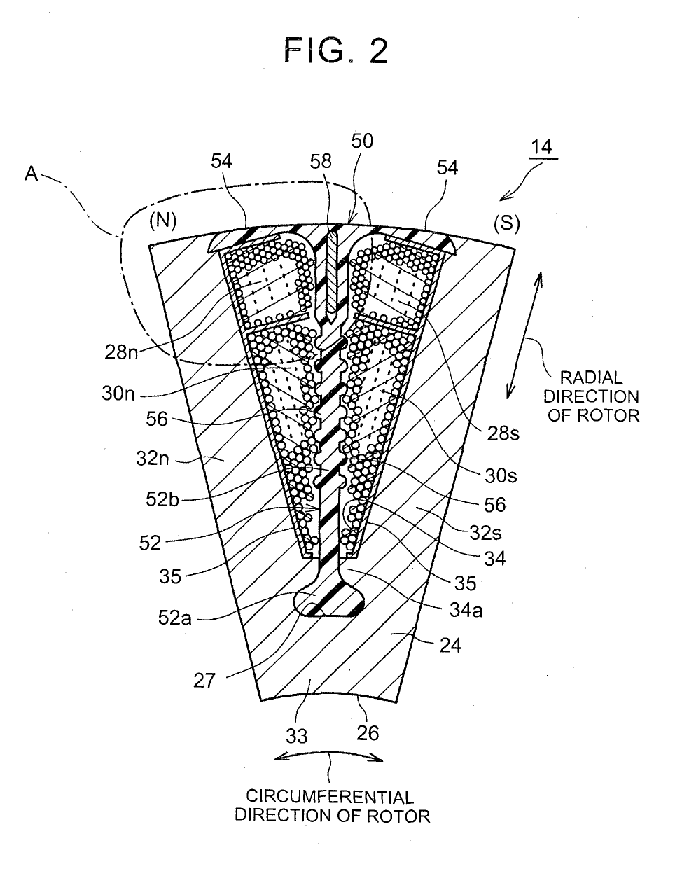

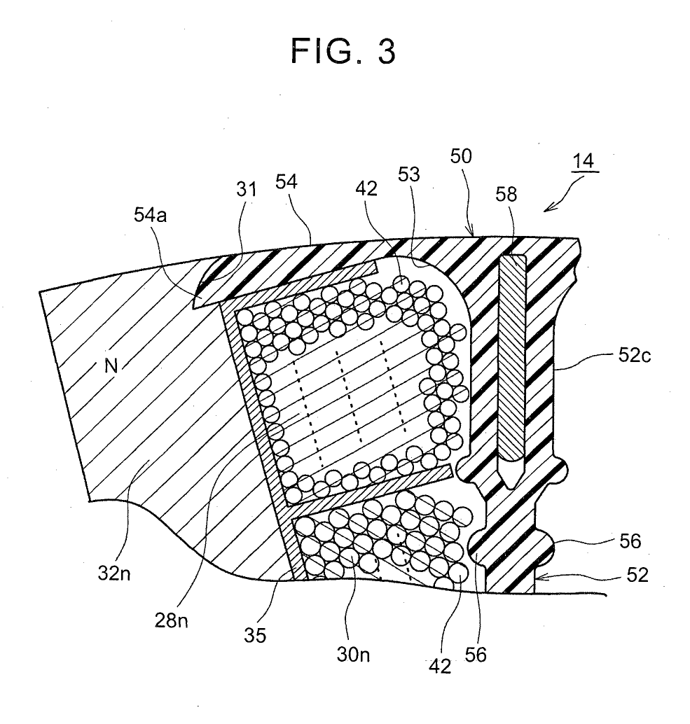

FIG. 2 is an enlarged view of a portion of the rotor 14 shown in FIG. 1. FIG. 3 is a further enlarged view of a portion A shown in FIG. 2. The rotor core 24 has a plurality of rotor salient poles 32n and 32s. The rotor salient poles 32n and 32s protrude radially outward, and are spaced from each other in the circumferential direction. It is to be noted herein that each rotor salient pole 32n is an N pole-forming salient pole that is magnetized to the N pole by the rotor coil as described below. Besides, each rotor salient pole 32s is an S pole-forming salient pole that is magnetized to the S pole by the rotor coil as described below. The rotor salient poles 32n and the rotor salient poles 32s are disposed alternately with each other in the circumferential direction. Furthermore, slots 34 are formed between the individual rotor salient poles 32n and 32s. Each slot 34 is formed by a space that has a generally trapezoidal sectional shape when viewed in the axis direction.

Rotor coils 28n, 28s, 30n and 30s of four different types are wound on every two rotor salient poles 32n and 32s that are adjacent to each other in the circumferential direction as shown in FIG. 2. Hereinafter, the rotor 14 will sometimes be described with regard to only the portion shown in FIG. 2. The rotor coil 28n is an N pole-inducing coil wound around a radially outer distal end-side portion of the rotor salient pole 32n by the concentrated winding method. The rotor coil 28s is an S pole-inducing coil wound around a radially outer distal end-side portion of the rotor salient pole 32s by the concentrated winding method. The rotor coil 30n is an N pole common coil wound around a radially inner proximal end-side portion of the rotor salient pole 32n. The rotor coil 30s is an S pole common coil wound around a radially inner proximal end-side portion of the rotor salient pole 32s. The rotor coils 28n, 28s, 30n and 30s of the rotor 14 are housed within the slots 34 formed between the rotor salient poles 32n and 32s. Furthermore, the rotor coils 28n, 28s, 30n and 30s are mutually connected by diodes that serve as rectification portions as described below.

An insulator 35 is disposed between the rotor salient poles 32n and 32s and the rotor coils 28n, 28s, 30n and 30s. This secures electrical insulation between the rotor core 24 and the rotor coils 28n, 28s, 30n and 30s. Besides, the insulator 35 has a portion that extends between the rotor coils 28n and 28s and the rotor coils 30n and 30s, whereby electrical insulation between the rotor coils of two types, more specifically, between the rotor coil 28n and the rotor coil 30n and between the rotor coil 28s and the rotor coil 30s, is enhanced.

In this embodiment, the rotor 14 further has a retainer member 50. The retainer member 50 performs the function of closing a radially outer opening portion of each slot 34 of the rotor 14 and retaining the rotor coils wound on the rotor core 24. Preferably, the retainer member 50 is formed from a non-magnetic material such as resin or the like. The adoption of a non-magnetic material prevents the retainer member 50 from being magnetically coupled to the rotor core 24, and achieves an advantage of avoiding adversely affecting the flow of magnetic flux in the rotor core 24.

As shown in FIG. 2, the retainer member 50 has a generally T-shaped sectional shape and a length that substantially corresponds to the entire length of the rotor core 24 in the axis direction. The retainer member 50 includes a leg portion 52 that extends in a radial direction and a pair of beam portions 54 that extend in opposite circumferential directions each other from a radially outer end portion of the leg portion 52.

A radially inner end portion 52a of the leg portion 52 of the retainer member 50 is fixed to a rotor yoke 34a that corresponds to a slot bottom portion of the rotor core 24. More concretely, the end portion 52a of the leg portion 52 is formed (or enlarged) to have a greater width in the circumferential direction than a portion 52b of the leg portion 52 that is located within the slot 34 (hereinafter, referred to as “in-slot portion 52b”). The rotor yoke 34a in the rotor core 24 has a latch groove 27 that extends in the axis direction and that corresponds in shape to the end portion 52a of the leg portion 52 of the retainer member 50. This latch groove 27 has an opening at an end portion of the rotor core 24 in the axis direction. Therefore, by inserting the retainer member 50 from that opening portion, the end portion 52a of the leg portion 52 can be latched into the latch groove 27. Due to this arrangement, the leg portion 52 of the retainer member 50 is fitted and fixed to the latch groove 27. Since the leg portion 52 of the retainer member 50 is fixed to the rotor core 24 in the foregoing manner, the radially outward movement of the retainer member 50 is restricted, so that it becomes possible to create retaining force that withstands the centrifugal force that acts on the rotor coils when the rotor 14 rotates.

The in-slot portion 52b of the leg portion 52 of the retainer member 50 is formed as a platy portion that radially extends between the rotor coils 28n and 30n positioned at one side in the circumferential direction and the rotor coils 28s and 30s positioned at the opposite side in the circumferential direction. Two circumferentially opposite side surfaces of the in-slot portion 52b of the leg portion 52 each have a plurality of protrusion portions 56 that are spaced from each other in the radial direction.

The protrusion portions 56 on the opposite surfaces of the leg portion 52 of the retainer member 50 are protruded circumferentially (i.e., in the circumferential direction) so as to be engageable with a coil winding 42 (see FIG. 3) that forms the rotor coils 30n and 30s that are the common coils among the rotor coils 28n, 28s, 30n and 30s disposed at the circumferentially opposite sides of the retainer member 50. More specifically, in this embodiment, the protrusion portions 56 are engageable with the coil winding 42 of the rotor coils 30n and 30s disposed on the radially inner side in each slot 34. Due to this arrangement, part of the centrifugal force that acts on the rotor coils 30n and 30s during rotation of the rotor 14 can be borne in a dispersed fashion by the leg portion 52 of the retainer member 50 because the coil winding 42 is engaged with the individual protrusion portions 56.

It is also permissible that the surface shapes of the rotor coils 30n and 30s that face the leg portion 52 of the retainer member 50 may be formed beforehand so that portions of the surfaces of the rotor coils 30a and 30s which correspond to the protrusion portions 56 are concave or hollow and portions thereof that correspond to portions of the leg portion 52 between the protrusion portions 56 protrude and therefore the protrusion portions 56 engage with the coil windings 42. Alternatively, the surfaces of the rotor coils 30n and 30s may be formed as flat surfaces beforehand, and the retainer member 50 may be inserted into the space between the two rotor salient poles 32n and 32s so that the protrusion portions 56 of the leg portion 52 bite into the rotor coils 30n and 30s and therefore the protrusion portions 56 are engaged with the coil windings 42.

Furthermore, although in this embodiment, the protrusion portions 56 have a generally semi-circular sectional shape, the protrusion portions 56 may also be formed so as to protrude in a sectional shape other than the generally semi-circular sectional shape, for example, in a triangular sectional shape or the like. Furthermore, the intervals at which the protrusion portions 56 are arranged in the radial direction and the number of protrusion portions 57 arranged may be changed as appropriate according to the thickness (diameter) of the coil winding 42 that forms the rotor coils 30n and 30s, the winding method of the coil winding 42, etc. For example, it suffices that at least one protrusion portion 56 is formed on the leg portion 52.

Furthermore, although in FIG. 2, the coil winding that forms the rotor coils 30n and 30s, which are common coils, appears to be larger in diameter than the coil winding that forms the rotor coils 28n and 28s, which constitute the induction coils, this arrangement is not restrictive. These coil windings may have the same diameter, or the coil winding of the rotor coils 28n and 28s may be larger in diameter.

A magnetic member 58 is enclosed in a radially outer end portion 52c of the leg portion 52 of the retainer member 50. the magnetic member 58 is formed by a metal sheet such as a silicon steel sheet or the like. Furthermore, the magnetic member 58 is disposed between the rotor coils 28n and 28s that are positioned adjacent to each other in the circumferential direction. Furthermore, the magnetic member 58 has a length that is equal to or substantially corresponds to the length of the rotor core 24 in the axis direction. The function of the magnetic member 58 will be described later.

As shown in FIG. 3, a circumferential-direction distal end portion 54a of each of the beam portions 54 of the retainer member 50 has a tapered sectional shape, and is fitted and latched into a latch depression portion 31 that is recessed in the circumferential direction in a radially outer end portion of the rotor salient pole 32n (or 32s). Therefore, since the distal end portions 54a of the beam portions 54 of the retainer member 50 are latched into the latch depression portions 31, it is possible to effectively create retaining force for retaining the rotor coils 28n, 28s, 30n and 30s while counteracting the centrifugal force during rotation of the rotor 14.

Furthermore, the latched state in which the distal end portion 54a of each of the beam portions 54 is latched into a corresponding one of the latch depression portions 31 so that radially outward movement is restricted can easily be established in an assembly process by inserting the retainer member 50 into a corresponding one of the slots 34 of the rotor core 24 from the end portion of the rotor 14 in the axis direction, similarly to the latched state of the end portion 52a of the leg portion 52 described above.

However, it is permissible to adopt a construction in which the circumferential-direction distal end portions 54a of the cantilevered beam portions 54 of the retainer member 50 are not latched to the end portions of the rotor salient poles 32n and 32s in the cases, for example, where the leg portion 52 and the cantilevered beam portions 54 of the retainer member 50 is able to provide a sufficient retaining force that can prevent the rotor coils 28n, 28s, 30n and 30s from flying out.

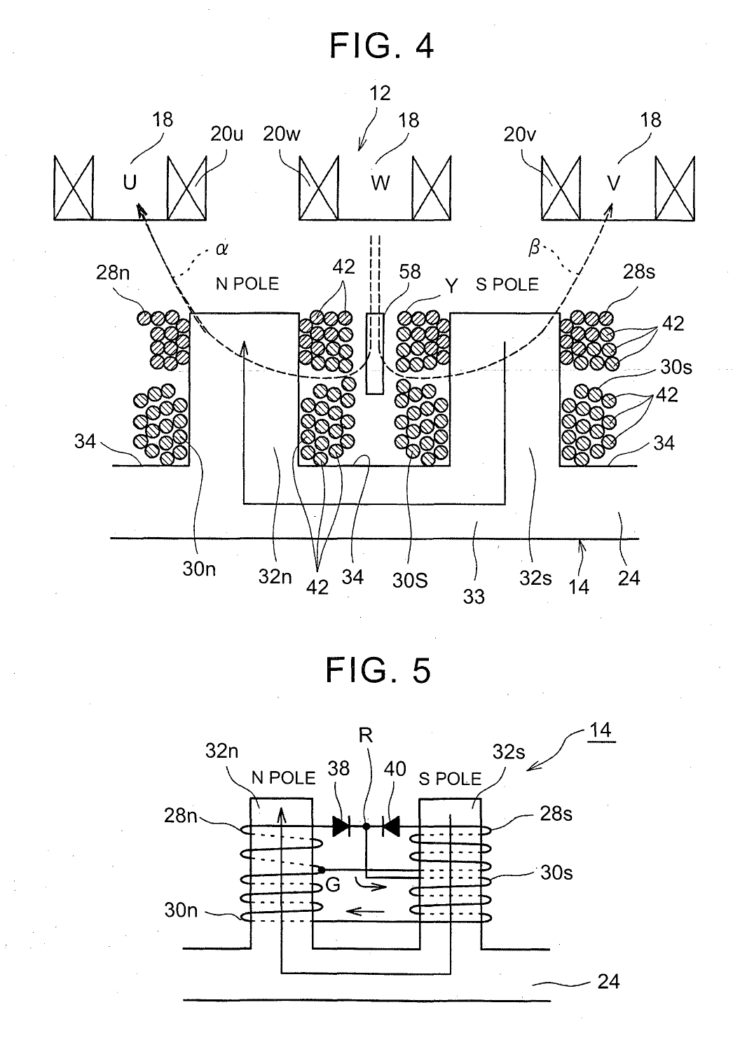

FIG. 4 is a schematic diagram showing how the magnetic flux generated by the induced currents that flow in the rotor coils flows in the rotor of the rotor electric machine shown in FIG. 1. FIG. 5 is a diagram in which rotor coils are connected to diodes, the diagram corresponding to FIG. 4.

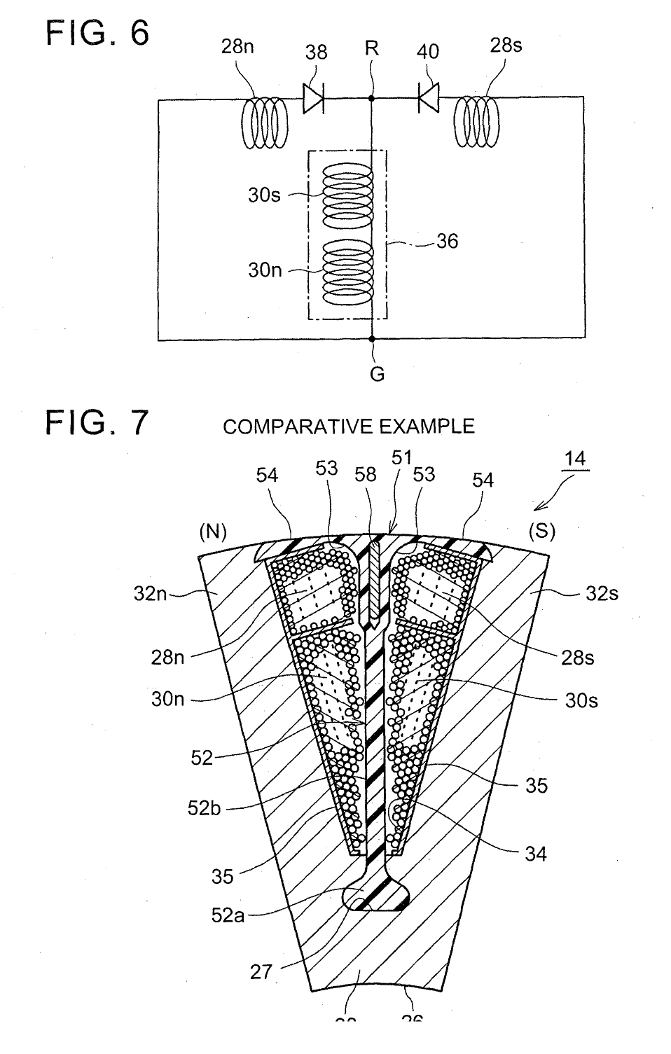

As shown in FIGS. 4 and 5, on a pair of rotor salient poles 32n and 32s adjacent to each other in the circumferential direction of the rotor 14, an end of the rotor coil 28n wound around the rotor salient pole 32n and an end of the rotor coil 28s wound around the rotor salient pole 32s are interconnected via a first diode 38 and a second diode 40 that are two rectifier elements. In this embodiment, a connection circuit of the plural (four) rotor coils 28n, 28s, 30n and 30s wound around the two rotor salient poles 32n and 32s adjacent to each other in the circumferential direction of the rotor 14 can be expressed as an equivalent circuit shown in FIG. 6. As shown by this equivalent circuit, an end of the rotor coil 28n and an end of the rotor coil 28s are interconnected at a connecting point R via the first diode 38 and the second diode 40 whose forward directions are opposite to each other.

Furthermore, on each pair of rotor salient poles 32n and 32s, an end of the rotor coil 30n wound around the rotor salient pole 32n is connected to an end of the rotor coil 30s wound around the rotor salient pole 32s. The rotor coils 30n and 30s are interconnected in series to form a common coil pair 36. On the other hand, another end of the rotor coil 30s is connected to the connecting point R, and another end of the rotor coil 30n is connected to another end of each of the rotor coils 28n and 28s that is opposite to or remote from the connecting point R, via a connecting point G.

Referring again to FIG. 4, as alternating currents are caused to flow through the stator coils 20u, 20v and 20w, the stator 12 generates a rotating magnetic field. This rotating magnetic field includes not only a magnetic field of a fundamental component but also a magnetic field of a harmonic component that is of higher order than the fundamental component. More specifically, the distribution of the magnetomotive force that produces the rotating magnetic field on the stator 12 does not become a sinusoidal distribution made up of only the fundamental component, but becomes a distribution that contains a harmonic component, due to the arrangement of the stator coils 20u, 20v and 20w of the three phases and the configuration of the stator core 16 based on the teeth 18 and the slots 19 of the stator 12.

In particular, in the concentrated winding method, the stator coils 20u, 20v and 20w of the three phases do not overlap with each other, so that the amplitude level of the harmonic component that occurs in the magnetomotive force distribution of the stator 12 increases. For example, in the case where the stator coils 20u, 20v and 20w are wound by the three-phase concentrated winding method, a harmonic component that is a spatial second-order component and a temporal third-order component of the input electricity frequency increases in amplitude level. The harmonic component that occurs in the magnetomotive force due to the arrangement of the stator coils 20u, 20v and 20w and the configuration of the stator core 16 is termed spatial harmonic.

When a rotating magnetic field that contains a spatial harmonic is applied from the stator 12 to the rotor 14, the magnetic flex fluctuation of the spatial harmonic produces fluctuation of leakage magnetic flux that leaks into space between the rotor salient poles 32n and 32s of the rotor 14. Therefore, induced electromotive force occurs in the rotor coils 28n and 28s. The rotor coils 28n and 28s, which are located at the distal end side of the rotor salient poles 32n and 32s, and are relatively close to the stator 12, produce induced current as the magnetic flux of the rotating magnetic field from the stator 12 links with the rotor coils 28n and 28s.

The rotor coils 30n and 30s, which are located at the proximal end side of the rotor salient poles 32n and 32s and are relatively remote from the stator 12, have a function of magnetizing mainly the rotor salient poles 32n and 32s. The current that flows through the rotor coils 30n and 30s is the sum of the currents that flow through the rotor coils 28n and 28s wound around the mutually adjacent rotor salient poles 32n and 32s, as can be understood from FIG. 6.

When induced electromotive force is produced in the rotor coils 28n and 28s, induced current flows through the rotor coils 28n and 28s and the rotor coils 30n and 30s according to the rectifying directions of the diodes 38 and 40. Therefore, the rotor salient poles 32n and 32s around which the rotor coils 30n and 30s are wound are magnetized so as to function as magnets whose polarity is fixed. Furthermore, the rotor salient poles 32n and 32s adjacent to each other in the circumferential direction are opposite to each other in magnetization polarity due to the winding directions of the individual rotor coils 28n, 28s, 30n and 30s and the rectification of the diodes 38 and 40. In the example shown in FIG. 5, the N pole is produced at the distal end of each rotor salient pole 32n around which the rotor coils 28n and 30n are wound, and the S pole is produced at the distal end of each rotor salient pole 32s around which the rotor coils 28s and 30s are wound. Thus, the N poles and the S poles are arranged alternately with each other in the circumferential direction of the rotor 14.

In the above-described rotary electric machine 10, the rotating magnetic field produced on the teeth 18 of the stator 12 by causing three-phase alternating electric currents to flow through the three-phase stator coils 20u, 20v and 20w acts on the rotor 14. Therefore, the rotor salient poles 32n and 32s of the rotor 14 are accordingly attracted to the rotating magnetic field of the teeth 18 so that the magnetic resistance with the rotor 14 lessens. Due to this, torque (reluctance torque) acts on the rotor 14.

Furthermore, as described above, since the induced current produced by linkage of the magnetic flux of spatial harmonic contained in the rotating magnetic field with the rotor coils 28n and 28s flows through the rotor coils 30n and 30s, the rotor salient poles 32n and 32s are magnetized with different polarities that alternate with each other in the circumferential direction. It is to be noted that the magnetic member 58 retained in the retainer member 50 is disposed between the mutually adjacent rotor salient poles 32n and 32s. Therefore, for example, as shown by interrupted line arrows αand β in FIG. 4, the magnetic member 58 makes it easier for the magnetic flux of spatial harmonic from the stator 12 to be drawn to the rotor 14 side, so that an increased amount of magnetic flux can be linked with the rotor coils 28n and 28s. Therefore, large induced current can be produced in each of the rotor coils 28n and 28s, so that the magnetomotive force of the rotor salient poles 32n and 32s can be increased.

The rotor salient poles 32n and 32s magnetized with the N pole and the S pole alternately in the circumferential direction interact with the rotating magnetic field produced by the stator 12 to exhibit attracting and repelling action. This attracting and repelling action causes torque (that corresponds to the magnet torque) to act on the rotor 14, so that the rotor 14 rotates synchronously with the rotating magnetic field produced by the stator 12. Thus, the rotary electric machine 10 is able to function as an electric motor that causes the rotor 14 to generate motive power by utilizing the electric power supplied to the stator coils 20u, 20v and 20w.

Incidentally, in the foregoing example, the two diodes 38 and 40 are used for every pair of rotor salient poles 32n and 32s adjacent to each other in the circumferential direction. This construction requires a number of diodes 38 and of diodes 40 that is equal to half the number of the rotor salient poles 32n and 32s. However, it is also possible to use only two diodes 38 and 40 for the entire rotor 14. More specifically, all the rotor coils 28n are connected in series and are handled as one series-connected induction coil of the N poles, and all the rotor coils 28s are connected in series and are handled as one series-connected induction coil of the S poles, and all the rotor coils 30n are connected in series and are handled as one series-connected common coils of the N poles, and all the rotor coils 30s are connected in series and are handled as one series-connected common coil of the S poles. Then, if the connection relation shown in FIG. 6 is used, it suffices that only two diodes 38 and 40 are provided.

According to the rotor 14 of the rotary electric machine of the embodiment, the magnetic member 58 is provided between every two mutually adjacent rotor salient poles 32n and 32s as described above. Therefore, the spatial harmonic that is contained in the rotating magnetic field produced by the stator 12 and that is a harmonic component that links with the rotor coils 28n and 28s can be effectively increased by the magnetic member 58. This makes it possible to increase the change in the magnetic flux density of the magnetic flux that links with the rotor coils 28n and 28s, increase the induced current produced in the rotor coils 28n and 28s, and enhance the magnetic force of the electromagnetic poles formed in the rotor salient poles 32n and 32s. As a result, the rotor magnetic force can be increased, and the torque of the rotary electric machine 10 can be improved.

Furthermore, the two circumferential-direction facing surfaces of the leg portion 52 of each retainer member 50 provided in the rotor 14 are provided with a plurality of protrusion portions 56 so that the protrusion portions 56 of the leg potion 52 engage with the coil winding 42 that forms the rotor coils 30n and 30s. Due to this arrangement, the centrifugal force that acts on the rotor coils 30n and 30s during rotation of the rotor 14 can be borne by the leg portion 52 of each retainer member 50. Therefore, the leg portion 52 and the beam portions 54 of each retainer member 50 can each contribute to creation of a retaining force that withstands the aforementioned centrifugal force. In consequence, in comparison with a construction in which the beam portions 54 alone serve to retain the rotor coils 28n, 28s, 30n and 30s against the aforementioned centrifugal force, the construction of this embodiment allows reduction of the wall thickness of a connecting portion between the leg portion 52 and the beam portions 54, so that the coil winding space between the rotor salient poles 32n and 32s can be maximized without being inconveniently restricted by a thick connecting portion between the leg portion 52 and the beam portions 54.

The aforementioned inconvenient restriction of the coil winding space will be described in more detail. In the case of a retainer member 51 whose leg portion 52 does not have on its surfaces a protrusion portion as shown in FIG. 7, the centrifugal force that acts on the rotor coils in radially outward directions during rotation of the rotor 14 is mainly borne by the beam portions 54 of the retainer member 51. Therefore, in order to stably retain the rotor coils in the state of being wound on the rotor salient poles against the centrifugal force, it is necessary to secure a certain strength of a connecting portion 53 between the leg portion 52 and the beam portions 54 of the retainer member 51 by increasing the radius of curvature of the curved surfaces of the connecting portion 53 and therefore increasing the wall thickness of the connecting portion 53. As a result, the coil housing space within each slot 34 and, particularly, the housing space for the rotor coils 28n and 28s wound on distal end-side portions of the rotor salient poles 32n and 32s will be inconveniently restricted or reduced. In consequence, in order to cope with the restricted space, it is necessary to reduce the diameter of the coil winding that forms the rotor coils 28n and 28s, reduce the number of turns of the coil winding, or take some other measure. This will likely impede efficient production of induced current.

In contrast, in this embodiment, the leg portion 52 of each retainer member 50 is provided with a plurality of protrusion portions 56 that engage with the coil winding 42 that forms the rotor coils 30n and 30s, so that the centrifugal force that acts on the rotor coils 30n and 30s is partly borne by the leg portion 52 as well. Therefore, the rotor coils can be stably retained in the state of being wound on the rotor salient poles 32n and 32s, without a need for the connecting portion 53 between the beam portions 54 and the leg portion 52 to have an inconveniently great wall thickness. Therefore, the radius of curvature of the curved surfaces that define the connecting portion 53 can be reduced to secure a large housing space for the coil windings 42.

Furthermore, since the centrifugal force that acts on the rotor coils is partly borne by the leg portion 52 of the retainer member 50, the centrifugal force of the rotor coils that act on the beam portions 54 of the retainer member 50 is reduced. This reduces the stress that occurs in and around the latch depression portions 31 of the rotor salient poles 32n and 32s into which the distal end portions 54a (see FIG. 3) of the beam portions 54 are latched, thus achieving another advantage of being able to restrain the occurrence of magnetic saturation in radially outer end portions of the rotor salient poles 32n and 32s.

The distribution of stress in the connecting portion 53 of the retainer member 50 of the rotor 14 of the embodiment was analyzed by using a simulation model. The analysis has confirmed that the stress that occurs in the connecting portion 53 of the retainer member 50 provided with the protrusion portions 56 on the leg portion 52 is reduced to about half the degree of stress that occurs in the connecting portion 53 of the retainer member 50 not provided with a protrusion portion 56. Furthermore, the distribution of stress in the vicinity of a latch depression portion 31 of each of the rotor salient poles 32n and 32s in a construction in which the leg portion 52 of the retainer member 50 was provided with protrusion portions 56 was analyzed using a simulation model. This analysis also confirmed that the stress in the vicinity of each latch depression portion 31 in the case where the leg portion 52 of the retainer member 50 is provided with the protrusion portions 56 is reduced to about half the degree of stress that occurs in the vicinity of each latch depression portion 31 in the case where the leg portion 52 of the retainer member 50 is not provided with a protrusion portion 56.

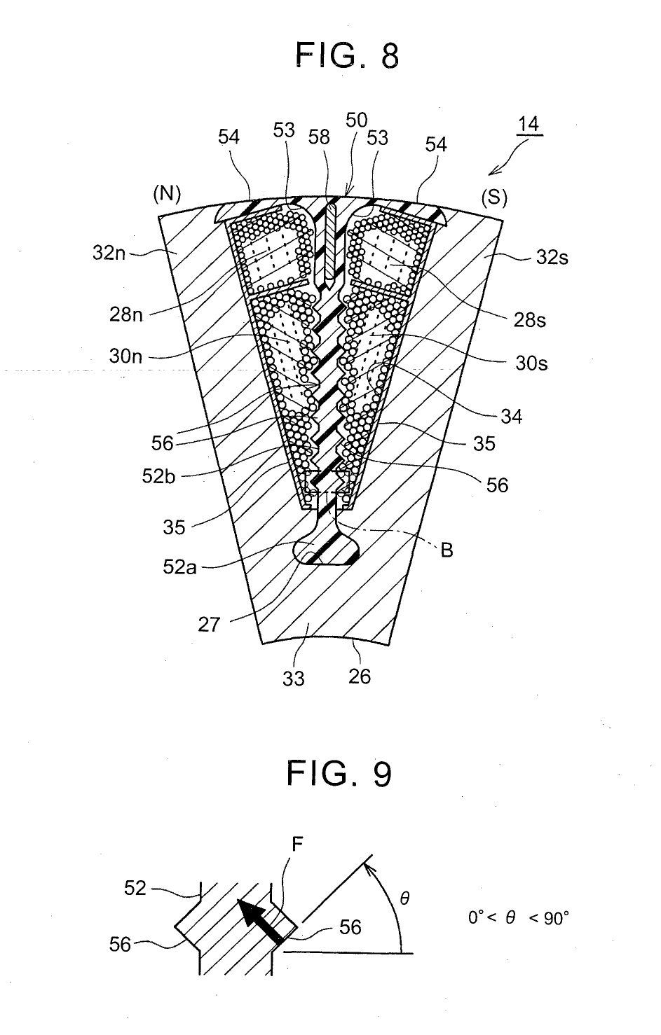

Next, with reference to FIGS. 8 to 10, modifications of the protrusion portions 56 formed on the leg portion 52 of the retainer member 50 will be described.

The protrusion portions 56 formed on the leg portion 52 of the retainer member 50 are not limited to protrusion portions that have a generally semi-circular sectional shape as in the foregoing embodiment. For example, as shown in FIG. 8, the protrusion portions 56 may have a triangular sectional shape that has a right-angle or substantially right-angle vertex. In this modification, it is preferable that, as shown in FIG. 9, the angle θ between a radially inner slope surface of each triangular protrusion portion 56 on which the centrifugal force of the rotor coils 28n, 28s, 30n and 30s acts and a direction orthogonal to a radial direction be set in the range of 0°<θ<90°. Since the protrusion portions 56 are formed so that the radially inward surfaces thereof are at an angle within the aforementioned range of angles, the centrifugal force of the rotor coils 30n and 30s that acts on the protrusion portions 56 in the direction of an arrow F in FIG. 9 can effectively be partly borne by the leg portion 52 of the retainer member 50.

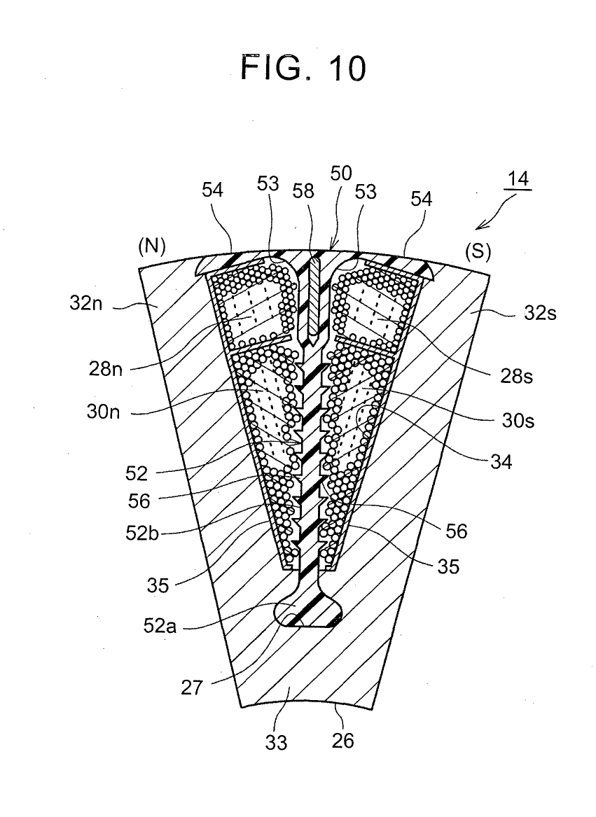

Furthermore, as shown in FIG. 10, the protrusion portions 56 on the leg portion 52 of the retainer member 50 may be formed so as to have a triangular sectional shape that has an acute-angle vertex. In this modification, too, it is preferable that the angle θ between a radially inner slope surface of each triangular protrusion portion 56 on which the centrifugal force of the rotor coils 28n, 28s, 30n and 30s acts and a direction orthogonal to a radial direction be set in the range of 0°<θ<90°.

Incidentally, the invention is not limited to the foregoing embodiment or modifications, but can be improved or changed in various manners within the scope covering matters described in the appended claims of this application and equivalents to the described matters.

For example, although in the foregoing embodiment and modifications, the magnetic member 58 is burred in the radially outer end portion of the leg portion 52 of the retainer member 50, this construction is not restrictive. For example, the magnetic member may be omitted. In this construction, too, the operation and effect of the leg portion of the retainer member bearing part of the centrifugal force that acts on the rotor coils 28n, 28s, 30n and 30s can be delivered without any particular difference.

Furthermore, although in the foregoing embodiment and modifications, the leg portion 52 of the retainer member 50 has a plurality of protrusion portions 56 on the surfaces thereof that face the rotor coils 30n and 30s, which correspond to common coils, this is not restrictive. For example, protrusion portions on the leg portion of the retainer member may also be provided on surfaces of the leg portion that face the rotor coils 28n and 28s, which correspond to induction coils. Furthermore, the protrusion portions of the leg portion of the retainer member may also be provided only on surfaces of the leg portion that face the rotor coils 28n and 28s.

In the construction mentioned above, spaces between the leg portion of the retainer member and at least the common coils or at least the induction coils may be filled with resin or the like so that the state in which the protrusion portions and the rotor coils are engaged or fixed together will be more certainly secured via the filler. This allows portions of the leg portion other than the protrusion portions to bear part of the centrifugal force that acts on the rotor coils, and therefore further enhances the retaining force that the retainer member creates for the rotor coils.

Furthermore, although in the foregoing embodiment and modifications, the rotor coils are divided into the common coils and the induction coils, the invention may be applied to any type of rotor for use in rotary electric machines which has rotor coils that are wound on rotor salient poles of the rotor core.

1. A rotor of a rotary electric machine, comprising:
a rotor core having a plurality of rotor salient poles that are disposed on an outer periphery of the rotor core in a circumferential direction of the rotor core;
rotor coils wound on the rotor salient poles; and
a retainer member provided so as to close a slot formed between the rotor salient poles,
wherein the retainer member has a leg portion which extends in a radial direction of the rotor between the rotor coils wound on two rotor salient poles adjacent to each other in the circumferential direction and whose radial-direction inner end portion is fixed to the rotor core, and a beam portion that is connected integrally to a radial-direction outer end portion of the leg portion,
the beam portion includes a first beam portion and a second beam portion that extend in opposite circumferential directions from each other from the radial-direction outer end portion of the leg portion so as to close a radial-direction outer side of the slot, and
the leg portion of the retainer member is provided with at least one protrusion portion that is protruded in the circumferential direction and that engages with a coil winding that forms the rotor coils.

2. The rotor according to claim 1, wherein
the at least one protrusion portion is a plurality of protrusion portions that are formed on two opposite surfaces of the leg portion in the circumferential direction and that are spaced from each other in the radial direction.

3. The rotor according to claim 1, wherein a circumferential-direction distal end portion of the beam portion of the retainer member is latched to a radial-direction outer end portion of a corresponding one of the rotor salient poles.

4. The rotor according to claim 1, wherein
the rotor coils include:
induction coils each of which is wound on a distal end-side portion of one of the rotor salient poles and in which induced current is produced due to linkage by magnetic flux of a rotating magnetic field formed by a stator;
a rectification portion connected to the induction coils so as to rectify the induced current; and
common coils that are each wound on a proximal end-side portion of one of the rotor salient poles and that magnetize the rotor salient poles with different polarities alternately in the circumferential direction by the induced current produced in each induction coil.

5. The rotor according to claim 4, wherein
the leg portion of the retainer member is located between the induction coils located at opposite sides in the circumferential direction in the slot, and
the leg portion of the retainer member is provided with a magnetic member.
